(19) United States
(12) Patent Application Publication
(10) Pub. No.: US 2012/0047829 A1
(43) Pub. Date: Mar. 1, 2012

(54) SHEET GLASS FIXING STRUCTURE AND WALL STRUCTURE

(75) Inventors: Norihide Imagawa, Tokyo (JP); Hideki Ogura, Tokyo (JP)

(73) Assignees: A Factory Inc., Shinjuku-ku, TOKYO (JP); TIS & Partners Co., Ltd., Chiyoda-ku, TOKYO (JP)

(21) Appl. No.: 12/808,207

(22) PCT Filed: Apr. 1, 2010
(86) PCT No.: PCT/JP2010/002410

§ 371 Date: Jun. 15, 2010

(30) Foreign Application Priority Data
Apr. 8, 2009 (JP) 2009-093847

(51) Int. Cl. E06B 3/663; E06B 1/36

(52) U.S. Cl. 52/204.1; 52/204.593

(57) ABSTRACT

A sheet glass fixing structure and wall structure that fix pairs of panes of sheet glass inside a frame, wherein the sheet glass fixing structure and wall structure comprise a frame made of a metal material; pairs of polygonal panes of sheet glass fixed inside the frame in parallel spaced condition; spacing members sandwiched between the pairs of panes of sheet glass to parallelly space the panes; and spacers installed between edge faces of the sheet glass and the frame and between the inside surfaces of the pairs of panes of sheet glass and the spacing members, which spacers are installed apart from corner regions of the sheet glass.

### TECHNICAL FIELD

This invention relates to a sheet glass fixing structure that uses sheet glass inside a framework installed in a building and a wall structure that uses sheet glass, and relates particularly to a sheet glass fixing structure and wall structure that install double-glazed sheet glass inside a framework and have high transparency and earthquake resistance.

### BACKGROUND ART

Conventionally, use of glass in a wall structure has been difficult from the aspect of earthquake resistance concerns, and use of sheet glass in a wall structure has been limited to utilization in only some buildings that employ a special structural system throughout the building.

In contrast, recent years have seen an increasing desire for wall structures that use highly transparent sheet glass from the viewpoints of design and functionality.

A problem with buildings that use much sheet glass is that when external forces act on the sheet glass, stress tends to concentrate at certain portions of the sheet glass, so that stress-concentration-induced breakage readily occurs. From this standpoint, highly transparent structures incorporating abundant sheet glass have been difficult to use as earthquake-resistance structural material, or to reinforce, and the difficulty of application to ordinary homes and offices has therefore been an issue.

So when utilizing sheet glass for a wall structure, the practices used to secure strength for earthquake resistance have generally been to adopt the method of using and fixing inside the framework an elastic cushioning material or the like that keeps external force from acting on the sheet glass or to adopt a structure for achieving strength by a structure having braces installed along the glass surface of the sheet glass. However, this causes a problem of making it hard to realize versatile design harmonious with interior design, because the impression of supplementary reinforcing material being used dominates.

In order to meet this desire, there is used as the sheet-glass-utilizing wall structure a structure obtained by forming recesses in the framework and fixedly mounting sheet glass therein. This structure is used to realize a wall structure having high transparency and visibility as well as earthquake resistance.

With this structure, however, utilization of sheet glass as a reinforcing component has its limit. Another problem is that it is difficult to enhance design qualities and freely configure space by, for example, cutting away part of the wall structure to make a door or form an open region for a corridor.

Although there exists a sheet glass fixing structure that overcomes these problems by improving the fixing structure around the edges of the sheet glass, use of a large amount of reinforcing material around the sheet glass to improve durability degrades the transparency of the sheet glass, causing a problem of restricting design aesthetics.

In renovation work exploiting the structure of an existing building, the structure limitations make it impossible to carry out large-scale remodeling with consideration to earthquake resistance, so that an issue of even further restriction of design arises. Moreover, when strength reinforcement is carried out in conjunction with renovation, reduction of the required work period and costs is desirable.

Because of this, the general practice has been to provide the framework structure with metal braces, but when deformation of the framework is prevented by installing braces that traverse the sheet glass along the glass surface, the field of vision through the sheet glass is obstructed by the braces, which is a drawback that degrades the appearance of the building and the visibility through the sheet glass. Another problem is that visibility deteriorates and the drawback grows worse in proportion as more large, high-tensile-strength braces are installed.

### PRIOR ART DOCUMENTS

### Patent Documents

Patent Document 1:
Japanese Patent Publication (A) No. 2006-37620

Patent Document 2
Japanese Patent Publication (A) No. 2007-198010

### BRIEF DESCRIPTION OF THE DRAWINGS

FIG. 1 is a front view showing a sheet glass fixing structure according to the present invention.

FIG. 2 is a sectional view of the sheet glass fixing structure according to the present invention.

FIG. 3 is a front view showing an embodiment of a wall structure using the sheet glass fixing structure according to the present invention.

FIG. 4 is a front view showing the plate of a wall structure according to the present invention.

FIG. 5 is a front view showing the plate and frames of a wall structure according to the present invention.

FIG. 6 is a front view showing another embodiment of the wall structure according to the present invention.

FIG. 7 is a front view showing still another embodiment of the wall structure according to the present invention.

### DISCLOSURE OF THE INVENTION

### Problem to be Overcome by the Invention

The object of the present invention is to overcome the foregoing problems by providing a sheet glass fixing structure and a wall structure that use sheet glass inside a framework installed in a building, and particularly a sheet glass fixing structure that installs double-glazed sheet glass inside a framework and has high transparency and earthquake resistance and a wall structure that uses sheet glass.

### Means for Solving the Problem

For achieving the aforesaid object, the sheet glass fixing structure according to this invention is, in a sheet glass fixing structure that fixes two panes of sheet glass inside a frame, a sheet glass fixing structure comprising a frame made of a metal material, two polygonal panes of sheet glass fixed inside the frame in parallel spaced condition, a spacing member sandwiched between the two panes of sheet glass to parallelly space the panes, and spacers installed between edge faces of the sheet glass and the frame and between the inside surfaces of the two panes of sheet glass and the spacing member, which spacers are installed apart from corner regions of the sheet glass.

Moreover, the sheet glass of the sheet glass fixing structure has an eight or more sided polygonal shape or a circular shape. Further, the spacers of the structure are installed one inch or more apart from the sheet glass corner regions.

Furthermore, for achieving the aforesaid object, the wall structure according to this invention is, in a wall structure comprising a plate formed with multiple lattice-like openings, a wall structure comprising a framework made of metal material and provided in an opening of a wall, pairs of polygonal panes of sheet glass fixed inside the framework in parallel spaced condition, spacing members that are part of the framework and sandwiched between the pairs of panes of sheet glass to parallelly space the panes, and spacers installed between the framework and the edge faces of the sheet glass and between the spacing members and the inside surfaces of the sheet glass, which spacers are installed apart from corner regions of the sheet glass.

The wall structure is also one in which the sheet glass has an eight or more sided polygonal shape or a circular shape. In addition, it is also a structure wherein the spacers are installed one inch or more apart from the sheet glass corner regions.

### Effects of the Invention

Since the sheet glass fixing structure according to the present invention has the structure set out in the foregoing, it has the following effects.

1. Upon deformation of the frame, compressive forces can be made to act dynamically from the frame through the spacers onto the sheet glass while preventing stress concentration, thereby making it possible to inhibit deformation of the frame by virtue of the compressive strength of the sheet glass and to exploit the sheet glass as a reinforcing component. Moreover, the two panes of sheet glass are installed on the inside of the frame through the medium of the spacing members, whereby the compressive strength increases, and the fixing structure is one of high strength capable of causing external forces from the spacing members, as well as the frame, to act on the sheet glass.

2. Since the sheet glass is polygonal with eight or more sides, stress can be readily dispersed to enhance earthquake resistance. In addition, stress can be deformed more evenly by establishing an ultimately polygonal shape that is substantially circular.

3. As the spacers are installed in the openings at a distance from the corners of the sheet glass, stress can be prevented from acting concentratedly within narrow bounds around the corners of the sheet glass, thereby making it possible to ensure a large breaking load of the sheet glass during deformation of the frame.

4. Owing to the assembly into the wall structure, it is possible to make the compressive force transferred from the frame to the sheet glass act diffusedly over the full length of the end faces along the sides of the sheet glass so as not to exceed the compressive strength of the sheet glass, and is further possible to make the compressive force transferred from the plate to the sheet glass act on the inside surfaces of the two panes of sheet glass, whereby the sheet glass can be efficiently exploited as a reinforcing component. As a result, it is a wall structure that, when incorporated into a building, is capable of utilizing sheet glass to prevent deformation of the framework, without particularly impairing the internal or external appearance of the building or the transparency of the sheet glass.

Thanks to the high strength, it is possible to provide an opening for a corridor or the like. Moreover, the deployment of plate pieces in the openings makes it possible to impart high earthquake resistance while utilizing much sheet glass and maintaining design aesthetics. A wall structure can therefore be provided that simultaneously offers earthquake resistance and design qualities, without loss of transparency.

5. Since the structure installs the two panes of sheet glass inside the frame without using numerous components or a complicated structure, the duration of the construction work can be shortened and cost reduced. Moreover, by giving the sheet glass inside the wall structure a polygonal shape with eight or more sides, external forces can be dispersed to heighten the strength of the wall as a whole.

6. The distancing of the spacers from the corners of the opening makes it possible to prevent concentration of compressive stress. In addition, the wall as a whole can be given a brace structure with design qualities by inserting the metal plate pieces in the openings in the framework to be reinforced.

### BEST MODE FOR WORKING THE INVENTION

The sheet glass fixing structure and wall structure according to the present invention will be explained in detail based on embodiments shown in the drawings.

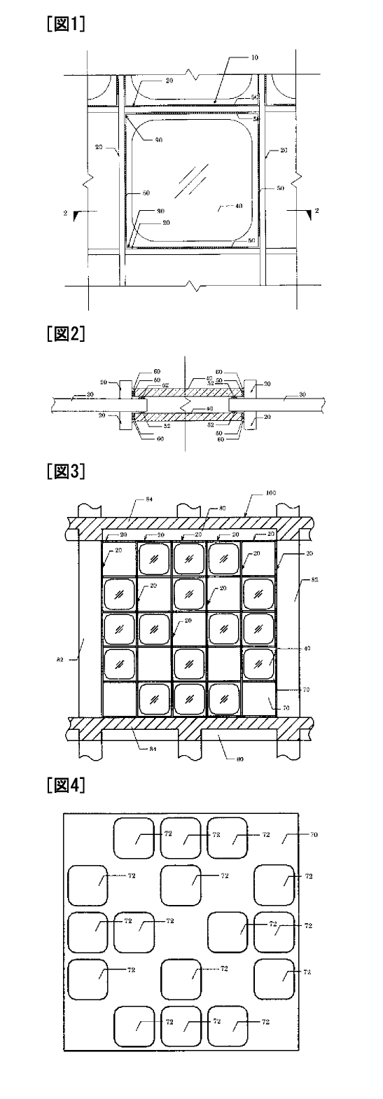

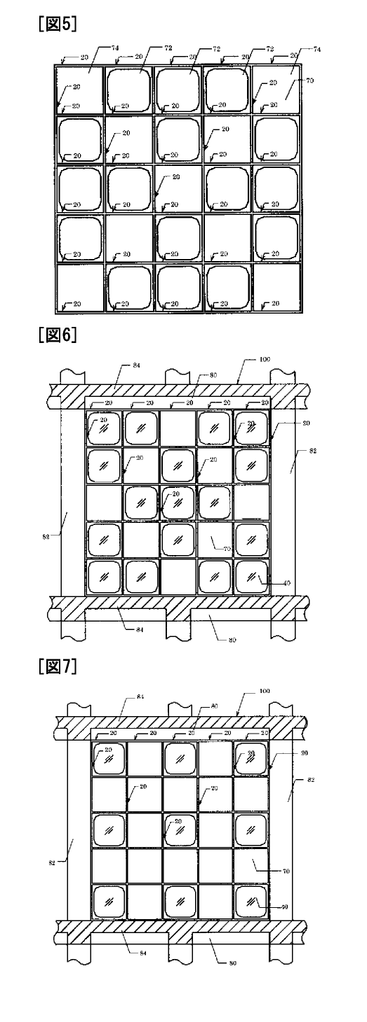

FIG. 1 is a front view showing a sheet glass fixing structure according to the present invention, FIG. 2 is a sectional view of the sheet glass fixing structure according to the present invention, and FIG. 3 is a front view of an embodiment of a wall structure using the sheet glass fixing structure according to the present invention. Further, FIG. 4 is a front view showing the plate of a wall structure according to the present invention, and FIG. 5 is a front view showing the plate and frames of a wall structure according to the present invention. FIG. 6 is a front view showing another embodiment of the wall structure according to the present invention, and FIG. 7 is a front view showing still another embodiment of the wall structure according to the present invention.

### First Embodiment

A sheet glass fixing structure 10 of the present invention indicated by the first embodiment has a configuration comprising a frame 20, a spacing member 30, two panes of sheet glass 40, and spacers 50.

The frame 20 is formed of a metal material. Although the frame 20 is formed rectangular in this embodiment, it can be given a polygonal configuration having three or more sides. Two panes of sheet glass 40 are mounted in the interior enclosed by the frame 20. In addition, the spacing member 30 is inserted into the interior periphery of the frame 20.

The spacing member 30 is a member for spacing the two panes of sheet glass 40 in parallel. As shown in FIG. 2, it is inserted between the two panes of sheet glass 40 to sandwich the spacers 52.

Although the frame 20 and the spacing member 30 are separate members in this embodiment, it is alternately possible to constitute the frame 20 and spacing member 30 integrally to obtain a frame structure whose spacing member becomes T-shaped in cross-section and mount the sheet glass therein. Moreover, it is also possible to form the spacing member integrally as a wall structural member.

The sheet glass 40 is mounted and fixed inside the frame 20 in two panes that sandwich the spacing member 30 to face each other with their surfaces in parallel. The type of sheet glass 40 is not particularly specified, and the structure can be obtained by fitting in any sheet glass among figured glass, float glass, tempered glass, laminated glass, pair glass, and the like. In addition, a mirror can be used for the sheet glass 40. Since the sheet glass 40 can be used as a reinforcing material, the wall panel strength can be increased with higher durability of the sheet glass 40.

Although rectangularly shaped sheet glass 40 is used in the first embodiment, the shape is not limited to rectangular, and use of polygonal sheet glass having three or more sides can be used. In particular, utilization of octagonal sheet glass 40 disperses the acting stress, making it possible to strengthen earthquake resistance further. In this case, the frame 20 can also be reconfigured to an octagonally assembled frame matched to the sheet glass. In addition, it is possible to inhibit occurrence of glass cracking from the corners of the sheet glass as starting points. Further, the effect of dispersing stress can be enhanced by using nearly circular multifaceted sheet glass of ultimately polygonal shape with eight or more sides.

In addition, the sheet glass 40 can be made circular. The circular sheet glass 40 can be inserted and mounted in a frame 20 reconfigured into circular shape. When the sheet glass 40 is made circular, compressive force or tensile stress does not concentrate at corners 90 even when the spacers 50 are installed over the full length of the end faces of the sheet glass 40, so that the action of external forces can made uniform.

The spacers (packings) 50 are installed on the end faces along the sides of the sheet glass 40 to be sandwiched between the frame 20 and the sheet glass 40. The spacers 50 are formed of a material softer than the frame and the sheet glass. Through the spacers 50, deformation due to vibration and the like can act dynamically from the frame 20 on the sheet glass 40 to utilize the compressive resistance force of the sheet glass 40 as reinforcing material, thereby strengthening earthquake resistance. Although the spacers can be installed continuously or discontinuously, concentration of compressive force and concentration of the action of tensile force at the corners 90 can be prevented by installing multiple spacers discontinuously and apart from the corners. As the durability of the glass against compressive force is high, external forces owing to earthquakes and the like can be positively transferred to enable a wall structure high in earthquake resistance.

Moreover, large breaking load of the sheet glass during deformation of the frame or plate can be ensured by installing the spacers 50 in a state apart from the corners 90 by 1 inch (25.4 mm) or greater.

In addition, other spacers (packings) 52 are installed between the spacing member 30 and the two panes of sheet glass 40. As shown in FIG. 2, the other spacers 52 are inserted at the periphery of the sheet glass. Although other spacers 52 formed as rectangular columns are inserted in this embodiment, their shape is not limited to this. Owing to the installation of the other spacers 52 on the spacing member 30 and the inner surface of the sheet glass 40, compressive force can be made to act in the thickness direction of the two panes of sheet glass 40 to exploit the durability of the sheet glass.

Moreover, a sealant 60 is applied at the end faces of the frame 20 and sheet glass 40 in this embodiment. The sealant 60 is applied to the outside of the sheet glass adjacent to the spacers to enhance the mounting performance of the frame 20 and the sheet glass 40 and thereby prevent detachment of the sheet glass 40.

In this embodiment, the two panes of sheet glass 40 are fitted inside the frame 20 to sandwich the spacing member 30 and face each other with their surfaces spaced apart in parallel. The spacers 50 and other spacers 52 are fitted by insertion between the sheet glass 40 and the frame 20 and spacing member 30, thereby being constituted to transfer external forces from the frame 20 to the peripheries of the sheet glass 40 and from the spacing member 30 to the inner surfaces of the two panes of sheet glass 40. The sheet glass is utilized as a reinforcing member by positively causing external forces to act on the two panes of sheet glass 40 inside the frame.

And the spacers 50 are installed discontinuously at locations apart from the corners 90. The corners 90 of the sheet glass 40 are kept out of contact with the corners 90 of the sheet glass 40 to prevent concentration of force. Breakage can be prevented and suitable reinforcement strength maintained by dispersing external forces from the frame 20 and spacing member 30 through the spacers 50 to act on the sheet glass.

### Second Embodiment

A wall structure 100 of the present invention indicated by the second embodiment shown in FIG. 3 has a configuration comprising a plate 70, framework 22, sheet glass 40, and spacers 50.

In this embodiment, wooden, metallic, concrete or other horizontal members 80 that individually support upper and lower floor slabs 84 and wooden, metallic, concrete or other vertical members 82 that support the horizontal members 80 are installed on a building outer wall region, and a metal framework 22 of stainless steel or the like assembled in a polygonal shape and incorporating therein vertical frame pieces and lateral frame pieces assembled like a lattice is held in place by the upper and lower horizontal members 80 and the left and the right vertical members 82.

The framework 22 is formed of rods made metal material that extend vertically and laterally. The plate 70 used in the wall structure 100 is partitioned into a lattice.

The wall structure according to this embodiment is formed by assembling a wall structure comprising the plate 70 and frames 20 within an interior region whose exterior is enclosed by the horizontal members 80 and vertical members 82, which are constituted by the beams, columns or the like of a building. Although not illustrated, the plate 70 can be partitioned into a lattice by arranging the rods constituting the frames 20 obliquely to the horizontal members 80 and vertical members 82.

The plate 70 is a plate material provided with multiple internal openings 72. It is formed of a steel plate or other hard material made of metal and is partitioned into a lattice by the framework 22. Two panes of the sheet glass 40 are fitted into each opening 72 enclosed by the framework.

The plate 70 can be utilized as the spacing member when fixing the two panes of sheet glass 40. As shown in FIGS. 2 and 3, a spacing member forming part of the plate 70 is disposed at an internal edge region enclosed by the framework 22 to abut the edges of the sheet glass 40 through spacers 50 and form the spacing member 30 for spacing the two panes of sheet glass in parallel. Since a part of the plate can be used as the spacing member 30, ready installation becomes possible to enable reduction of the construction period during renovation. In addition, the structure can be one that forms the plate 70 and the framework 22 integrally.

The sheet glass 40 is inserted within the framework 22 having the openings 72 arranged therein.

Although rectangular sheet glass 40 is used in this embodiment, it is possible to adopt a structure in which polygonal sheet glass having three or more sides is inserted in the interior, and the structure can be one that uses sheet glass of a polygonal shape different from the shape of the frame. Although not illustrated, insertion of octagonal sheet glass of a shape obtained by cutting off the corners of the sheet glass located at the corners of the rectangles makes it possible to avoid concentration of external forces at the corners, thereby dispersing force within the sheet glass and enabling a wall structure of high durability. A structure obtained by inserting circular glass is also possible.

The openings 72 in which the sheet glass 40 is fitted have the spacers 50 and 52 attached between the frame 20 and sheet glass end faces 42 and between the plate 70 and the edge regions of the sheet glass. The spacers 50 and 52 are formed of a material softer than the sheet glass 40 and frames 20. In this embodiment, the spacers 50 and 52 are installed discontinuously and apart from the corners 90 formed by the frames 20, thereby preventing concentration of tensile force and stress at the corners 90.

In addition, the other spacers 52 are installed at locations one inch (25.4 mm) or more apart from the corners 90, thereby making it possible to ensure a large breaking load of the sheet glass during deformation of the frame or plate.

In addition, detachment of the sheet glass is prevented in this embodiment by applying the sealant 60 between the sheet glass end faces 42 and the framework 22.

When the sheet glass 40 is given an octagonal shape, the structure can be one obtained by inserting the spacers 50 between the sheet glass 40 and the framework 22 to extend completely around the end faces of the sheet glass 40. Similarly, when circular sheet glass is used, it is also possible to adopt a structure obtained by inserting the spacers to extend completely around the end faces. And it is also possible to adopt a structure obtained by inserting the other spacers 52 between the sheet glass 40 and the spacing member 30 to extend completely around the edges of the sheet glass.

In the wall structure 100, the strength of the wall as a whole can be increased by virtue of the locations where the openings 72 are opened in the plate 70. For example, in FIG. 3 the wall structure 100 is braced by arranging closed regions 74 diagonally from its corners, and closed regions 74 are similarly arranged in diagonal directions in FIG. 6. And in FIG. 7, closed regions 74 are arranged in every other row in the horizontal direction and the vertical direction. The embodiments shown in FIGS. 3, 6 and 7 are not limitative, and the openings 72 and closed regions 74 can be variously arranged to enable use of the closed regions 74 as braces with respect to the horizontal members 80 and vertical members 82.

Moreover, it is also possible adopt a structure obtained by inserting in the openings 72 metal plate pieces instead of the sheet glass 40. An example would be where a plate 70 having an opening 72 located inside every frame 20 utilizes sheet glass 40 inside some of the frames and polygonal stainless steel or other metal plate pieces as the plate pieces fitted in the remaining openings 72 and the sheet glass 40 and the metal plate pieces individually have their outer peripheral edge regions fixed along the frame interior. The multiple openings 72 closed by the metal plate pieces are arranged on the left and right in the up-down direction along the diagonals of the wall structure 100, so that the metal plate pieces form a brace structure.

By inserting two metal plate pieces inside the framework 22 instead of simply the closed region 74, a wall structure of high strength can be realized, and the whole wall can be reinforced utilizing the strength of the inserted plate pieces. A wall structure having space-partitioning and building-reinforcement features can be obtained by establishing closed areas to an extent that does not impair the transparency of the wall structure.

### PARTS LIST

10 . . . sheet glass fixing structure, 20, 22 . . . frame/framework, 30 . . . spacing member, 40 . . . sheet glass, 42 . . . end face, 50, 52 . . . spacer (packing), 60 . . . sealant, 70 . . . plate, 72 . . . opening, 74 . . . closed region, 80 . . . horizontal member, 84 . . . floor slab, 90 . . . corner, 100 . . . wall structure

1. A sheet glass fixing structure that fixes two panes of sheet glass inside a frame, wherein the sheet glass fixing structure is characterized in comprising:
a frame made of a metal material;
two polygonal panes of sheet glass fixed inside the frame in parallel spaced condition;
a spacing member sandwiched between the two panes of sheet glass to parallelly space the panes; and
spacers installed between edge faces of the sheet glass and the frame and between the inside surfaces of the two panes of sheet glass and the spacing member, which spacers are installed apart from corner regions of the sheet glass.

2. The sheet glass fixing structure of claim 1, characterized in that the sheet glass has an eight or more sided polygonal shape or a circular shape.
the cylindrical casing has a structure formed entirely of resin.

3. The sheet glass fixing structure of claim 1, characterized in that the spacers are installed one inch or more apart from the sheet glass corner regions.

4. The sheet glass fixing structure of claim 2, characterized in that the spacers are installed one inch or more apart from the sheet glass corner regions.

5. A wall structure comprising a plate formed with multiple lattice-like openings, wherein the wall structure is characterized in comprising:
a framework made of metal material and provided in an opening of a wall;
pairs of polygonal panes of sheet glass fixed inside the framework in parallel spaced condition;
spacing members that are part of the framework and sandwiched between the pairs of panes of sheet glass to parallelly space the panes; and
spacers installed between the framework and the edge faces of the sheet glass and between the spacing members and the inside surfaces of the sheet glass, which spacers are installed apart from corner regions of the sheet glass.

6. The wall structure of claim 4, characterized in that the sheet glass has an eight or more sided polygonal shape or a circular shape.

7. The wall structure of claim 4, characterized in that the spacers are installed one inch or more apart from the sheet glass corner regions.

8. The wall structure of claim 5, characterized in that the spacers are installed one inch or more apart from the sheet glass corner regions.
